(19) United States
(12) Patent Application Publication
(10) Pub. No.: US 2007/0165926 A1
(43) Pub. Date: Jul. 19, 2007

(54) Data processing system for compartmental analysis

(75) Inventors: Timo Paulus, Aachen (DE); Dragos-Nicolae Peligrad, Aachen (DE); Lothar Spies, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,704

(22) PCT Filed: May 3, 2005
(86) PCT No.: PCT/IB05/51446

§ 371 Date: Nov. 6, 2006

(30) Foreign Application Priority Data
May 10, 2004 (EP) 04102015.7

(51) Int. Cl. G06K 9/00

(52) U.S. Cl. 382/128

(57) ABSTRACT

The invention relates to a data processing system (1) for the evaluation of image data, particularly of PET-images (I), that represent the time varying concentration of a tracer substance like F-MISO in an object (20). The data processing system (1) comprises a library module (48) with analytical solutions (Cⱼ(t)) for several compartment models. Preferably the library also contains the analytical gradients with respect to the parameters of interest. From the library an appropriate solution for each study can be chosen by a user. The use of analytical functions together with the information about the error (σ_{A}(ₜ)) of the input data (either via noise models 43 or via a simulation 44) allows to extract all parameters mandatory to fully understand the kinetics of complex models (more than one tissue compartment) on a per-voxel basis in a robust way in real-time.

The invention relates to a data processing system for the evaluation of image data that represent the time varying concentration of at least one tracer substance in an object, a record carrier with a computer program for such a data processing system, and an examination apparatus with such a data processing system.

When using medical imaging devices such as CT (Computed Tomography), MR (Magnetic Resonance), PET (Positron Emission Tomography), SPECT (Single Photon Emission Computed Tomography) or US (Ultrasound) to display functional or morphological properties of a patient under study, either a number of static scans or a contiguous time series of dynamic scans is recorded. To obtain the medical information of interest encoded in these images in certain applications a compartmental analysis of the underlying chemical, biological and physiological processes has to be accomplished. Compartmental analysis is based on a special type of mathematical model for the description of the observed data, in which physiologically separate pools of a (tracer) substance are defined as “compartments”. The model then describes the concentration of said substance in the different compartments, for example in the compartment of arterial blood on the one hand side and in the compartment of tissue on the other hand side (it should be noted, however, that in general compartments need not be spatially compact or connected). Typically, there is an exchange of substance between the various compartments that is governed by differential equations with (unknown) parameters like exchange rates. In order to evaluate a compartment model for a given observation, the differential equations have to be solved and their parameters have to be estimated such that the resulting solutions optimally fit to the observed data. Details on the technique of compartmental analysis may be found in the literature (e.g. S. Huang and M. Phelps, “Principles of Tracer Kinetic Modeling in Positron Emission Tomography and Autoradiography” in: M. Phelps, J. Mazziotta, and H. Schelbert (eds.), Positron Emission Tomography and Autoradiography: Principles and Applications for the Brain and Heart, pp 287-346, Raven Press, New York, 1986).

Current methods either apply compartmental models on larger regions of interest, that have to be defined prior to the analysis and depend on previous knowledge, which can introduce an unwanted bias into the analysis, or use simplified (e.g. linearized) models, which can not supply the full information comprised within the recorded data.

Based on this situation it was an object of the present invention to provide means for the evaluation of image data with respect to a compartment model that yield accurate results while integrating easily into the clinical workflow.

This object is achieved by a data processing system according to claim 1, a record carrier according to claim 9, and an examination apparatus according to claim 10. Preferred embodiments are disclosed in the dependent claims.

The data processing system according to the present invention serves to the evaluation of image data that represent the time varying concentration of at least one tracer substance in an object. The image data may for example be PET data that record the radioactive decay of the tracer substance in a patient, wherein the spatial distribution of said substance contains information on physiological or metabolic processes in the body. The data processing system comprises the following components:

(a) A library module comprising parameter dependent analytical functions that represent solutions to at least one given physiological compartment model. Preferably, the analytical functions are non-linear with respect to their independent variable (time) and/or the parameters. The library module is typically implemented by software and data that are stored in a memory (for example RAM, hard disk, CD) of the data processing system. As described above, a compartment model describes the distribution of a substance between different compartments and the exchange of substance between these compartments. Typically the type of compartment model is characterized by the number of different compartments that are considered and the possibilities of exchange between these compartments.

(b) An analysis module that is coupled to the library module and that is adapted to fit the parameters of said analytical functions of the library module (for a given compartment model) to the image data. The analysis module is typically implemented as computer software that can execute the required mathematical operations, said software being stored in a memory of the data processing system. Moreover, the analysis module comprises a (micro)processor for the execution of the algorithms on the image data.

A data processing system of the aforementioned kind has the advantage that it makes use of analytical solutions of one or more given compartment models, which allows real-time computation of complex compartment models and the evaluation of image data with high spatial resolution, i.e. on a voxel basis. Moreover, the resulting solutions are very robust.

In the most simple case, the library contains analytical functions for one compartment model only, making the data processing system apt to perform a fast routine analysis of image data. Preferably however, the library module comprises analytical functions for a set of several compartment models of different complexity and design, from which a user may select by some interactive input device like a keyboard or a mouse. The user may thus choose a compartment model which he considers as optimal for the description of the underlying physiological processes.

According to a further development of the library module, it comprises analytical expressions for the gradients of the analytical functions with respect to their parameters. These expressions may then be used for a fast and accurate estimation of the parameters to the observed image data in fitting procedures like gradient descent (with respect to said parameters), Gauss-Newton, or Levenberg-Marquard (cf. J. Dennis, “Nonlinear Least-Squares” in: D. Jacobs (ed.), State of the Art in Numerical Analysis, pp. 269-312, Academic Press; K. Levenberg, “A Method for the Solution of Certain Problems in Least Squares”, Quart. Appl. Math., Vol. 2, pp 164-168, 1944; D. Marquardt, “An Algorithm for Least-Squares Estimation of Nonlinear Parameters”, SIAM J. Appl. Math. Vol. 11, pp 431-441, 1963). The analytical expressions for the gradients are therefore a reasonable addition to the analytical functions that describe the compartment model.

According to a preferred embodiment of the library module, the analytical functions have the general form according to the following equation

$${C}_{j} ( t ) ∝ {ⅇ}^{- {λ}_{k} t} {\sum }_{i = 1}^{n} \frac{{a}_{i}}{{( {c}_{i} - {λ}_{k} )}^{{b}_{i} + 1}} [ Γ ( {b}_{i} + 1 ) - Γ ( {b}_{i} + 1 , ( {c}_{i} - {λ}_{k} ) t ) ]$$

wherein:

Cⱼ is the tracer concentration in a compartment j;

aᵢ, bᵢ, cᵢ and λₖ are parameters of which at least some shall be fitted to the image data;

$$Γ ( x ) = {\int }_{0}^{∞} {ⅇ}^{- t} {t}^{x - 1} ⅆ t$$

is the gamma function; and

$$Γ ( a , x ) = {\int }_{x}^{∞} {ⅇ}^{- t} {t}^{a - 1} ⅆ t$$

is the incomplete gamma function.

As can be shown by mathematical analysis, these analytical functions are suited to described a large class of different compartment models and input functions. In a typical case, the parameters aᵢ, bᵢ, cᵢ describe the plasma concentration of the tracer substance, while the λₖ depend on exchange rates of the compartment model. The parameters aᵢ, bᵢ, cᵢ may then separately be determined by fitting them to a measured plasma concentration of the tracer.

According to another preferred embodiment, the data processing system is adapted to estimate the errors of the fitted parameters. This estimation will typically be based on a calculation of error data sets from the image data, wherein this calculation may either be done by means of a noise model or by simulation of the image acquisition process. The estimation of parameter errors is a valuable additional information for the user of the data processing system that allows a judgment on the reliability of the calculated results. Furthermore, the consideration of errors in a weighted fit increases the stability of the parameter estimation.

The data processing system preferably is adapted to evaluate the compartment model(s) for every picture element (pixel) or volume element (voxel) of the image data or for larger regions of interest that comprise several pixels or voxels. Thus the user may decide with which spatial resolution the image data are evaluated, wherein the finest resolution of a pixel or voxel is feasible due to the use of analytical functions.

The data processing system may optionally be adapted to register the image data and/or to register maps of the fitted parameters or the like with further images that originate from the same or a different modality (for example PET, SPECT, CT, MR, or US). During preprocessing, the raw image data may for example be co-registered with previous image frames from the same object and the same modality. At the output stage, a registration of the calculated parameter maps with images like CT-scans allows for a fusion of physiological and morphological data.

The data processing system may further comprise a display unit for the display of image data, maps of the fitted parameters, maps of estimated parameter errors or the like. The graphical display of the available information is an important aspect of the data processing system as it allows a physician a fast, intuitive access to the available information.

The invention further comprises a record carrier, for example a floppy disk, a hard disk, or a compact disc (CD), on which a computer program for the evaluation of image data that represent the time varying concentration of at least one tracer substance in an object is stored, wherein said program is adapted to fit the parameters of analytical functions (the functions representing solutions to at least one given physiological compartment model) to said image data.

Finally, the invention comprises an examination apparatus with an imaging device for generating image data that represent the time varying concentration of at least one tracer substance in an object, and a data processing system of the kind described above. The imaging device may for example be a PET-scanner.

The aforementioned record carrier and examination apparatus rely on the features of a data processing system as it was described above. For more information on details, advantages and further developments of the record carrier and the examination apparatus, reference is therefore made to the description of the data processing system.

These and other aspects of the invention will be apparent from and elucidated with reference to the embodiment(s) described hereinafter.

In the following the invention is described by way of example with the help of the accompanying drawings in which:

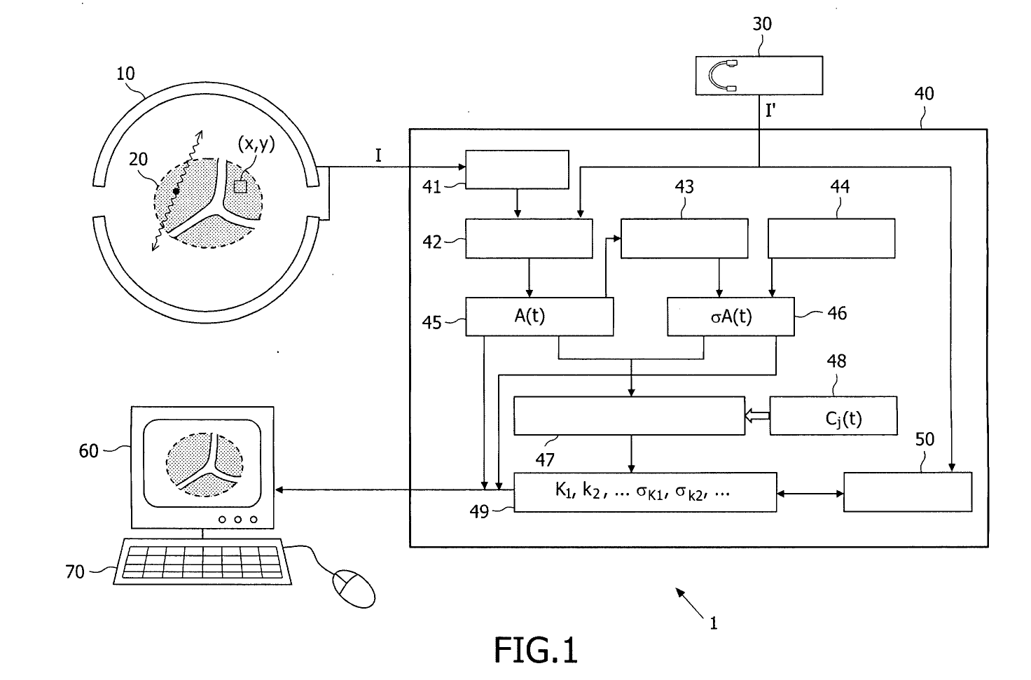

FIG. 1 schematically shows an examination apparatus for a compartmental analysis of image data according to the present invention;

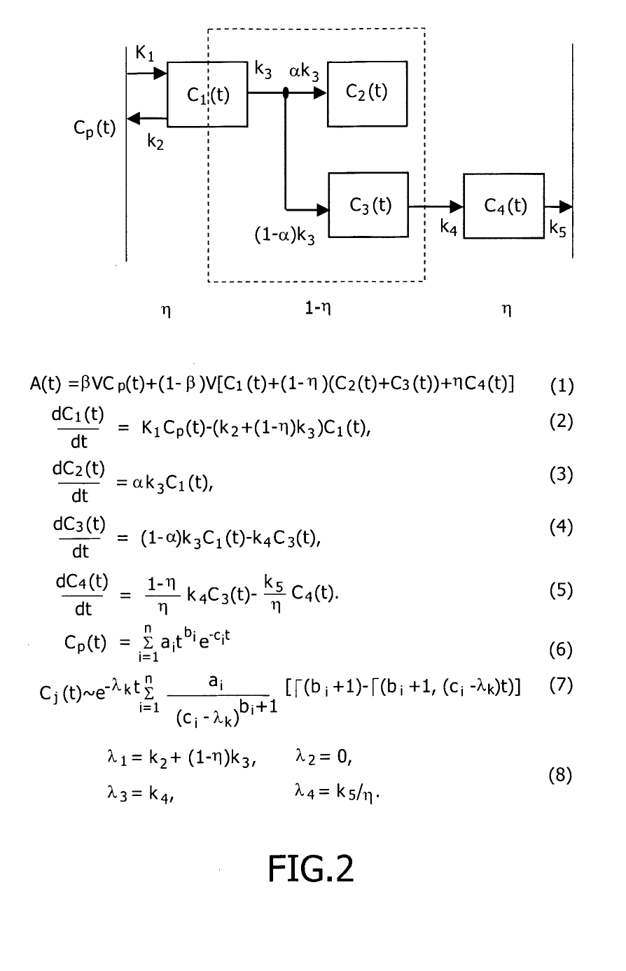

FIG. 2 depicts an example of a compartment model with four compartments and some of the corresponding mathematical equations.

In the upper left corner of FIG. 1 a PET-scanner 10 is diagrammatically sketched. The scanner 10 surrounds an object, for example a tissue region 20 of interest in a patient. The tissue contains a tracer substance like F-MISO (F-Fluoromisonidazole). Said tracer substance distributes differently in blood and in tissue according to the rate of external input (typically by injection), the exchange rates between the different organs/spacles, the rate of metabolic decay and the like. The tracer substance contains a radioactive marker atom that emits a positron which annihilates into two γ quanta. These γ quanta can be determined by the PET-scanner 10 yielding raw image data I that are transmitted to a computer 40. These image data represent the total radioactivity coming from voxels at positions (x,y) in the tissue 20 according to the image resolution of the PET-scanner 10.

Instead of the described PET-scanner 10, any other medical imaging device (like PET, SPECT, CT, MR, or US) could be used provided that it is suited to map the spatial distribution of the (tracer) substance in a monitored region.

In the following, the data processing system 1 will be described in more detail. This data processing system 1 mainly consists of the aforementioned data processing unit or computer 40 to which a display unit like a monitor 60 and an input device like a keyboard 70 with a mouse are coupled.

The computer 40 receives as input the full set of recorded images I (either several static scans or the 4-dimensional time series of scans) and generates from this input maps of all the relevant chemical, biological and physiological parameters on a per-voxel basis. The computer 40 contains the usual hardware components like memory, I/O-interface(s), and microprocessor(s). More important for the present invention is the functional structure of the computer 40 which is primarily determined by software that is stored in the available memories and executed by the available processors. This functional structure is illustrated by the blocks in FIG. 1 and will be explained in connection with the following description of the operation of the data processing system 1:
1. Data acquisition and pre-processing:
a. Transfer of the input data I (static/dynamic time series) from the medical imaging device 10 to the computer 40.
b. Data correction (e.g. partial volume effects, etc.) in module 41.
c. Co-registration of different data sub-sets in module 42 (e.g. different time frames or data I′ from different modalities like a CT-scanner 30), yielding the preprocessed input data A (t) (module 45). The co-registration allows for example to compensate for different positioning of the patient at different times or on different imaging devices.
d. Calculation of error data sets σ_{A(t)} (module 46) from the input data A (t) either by means of a noise model 43 or by a simulation module 44 incorporating aspects as e.g. geometry and hardware specifications of the medical imaging device 10.
2. Visualization of the input data and the error of the input data:
Optionally, the input data A (t) (module 45) and the error of the input data σ_{A(t)} (module 46) may be visualized on the monitor 60.
3. Selection of the region of interest (ROI):
Optionally, the user may select a region of interest (ROI) on the input data A (t) where further analysis is desired.
4. Mathematical Analysis:
a. Selection of a compartment model from a list containing multiple alternatives by the user.
b. Specification of model parameters by the user: start value, lower and upper bounds, additional fixed parameters.
c. Selection of analysis method by the user: per-voxel within ROI (one pass/multi pass with at first low and then increasing resolution) or regional (average of ROI).
d. Optional selection of a noise model (e.g. Poisson) for module 43.
e. Selection of the optimization method by the user (e.g. Levenberg-Marquard, Gauss-Newton, Simplex).
f. Analytical solution of the underlying differential equations of the compartment model in the analysis module 47 making use of analytical functions that are provided by a library module 48. If necessary, an analytical computation of the gradients with respect to the model parameters is performed, wherein the gradients are preferably provided by the library module 48, too.
g. Optimization of the solutions with respect to the relevant parameters (specified under a. and b.) using a weighted least squares fit to the input data. The fitting procedure may preferably take the errors of the input data into consideration (typically giving data with a high error less weight than those with a smaller error), since a weighted fit improves the stability of the parameter estimation.
h. Storage of the final result of the optimization (i.e. parameters K₁, k₂, . . . ), parameter error estimates and statistical information (χ²/d.o.f., correlation matrix, etc.) in block 49.
5. Visualization of results:
a. Visualization of parametric maps of all relevant parameters (K₁, k₂, . . . ) of block 49 on the monitor 60.
b. Possibility to fuse the maps with additional medical images I′ (e.g. anatomical scans from CT 30) in module 50, thus bringing together functional, morphological, and anatomical information.
c. Visualization of the resulting model curve (e.g. time activity curve for dynamic scans) using the optimized set of parameters superimposed on the input data.

The described apparatus adapts easily into the clinical workflow, allowing for extraction of the relevant parameters of the examination on a per-voxel basis and visualizing them as parametric maps, which can be fused with additional (e.g. anatomical) information to improve diagnosis and resulting treatment. It integrates all steps starting from transfer of the input data from the medical input device to visualization of the results. Input data has not to be converted multiple times between various formats for each processing step. The apparatus makes full compartmental analysis on a per-voxel basis possible for a wide class of compartmental models, which can easily be expanded. The models can be adapted to the special examination of interest by modifying parameter properties (e.g. bounds) by user interaction.

The apparatus may e.g. be applied in oncology for the compartmental analysis of dynamic PET data which allows for the determination of various physiological parameters, e.g. oxygenation of tumor cells, which play an important role in RTP (radio therapy planning). Analysis of the data using the proposed apparatus enables refined planning incorporating the information drawn from the parametric maps. Moreover, quantification of RT success is facilitated in subsequent follow-up studies based on the comparison of the parametric maps before and after RT.

FIG. 2 depicts an exemplary compartment model with four compartments and the corresponding equations (cf. J. J. Casciari et al., “A Modeling Approach for Quantifying Tumor Hypoxia with [F-18]fluormisonidazole PET time-activity data”, Med. Phys. 22(7) (1995), pp 1127-1139). The compartment model describes the uptake of the tracer F-MISO from arterial blood and its distribution in tissue. The tracer is present in the blood with the plasma concentration C_{P} which is predetermined by the clinical protocol (injection timing etc.). The tracer passes from the blood to the tissue, where it distributes between an extra-cellular and an intra-cellular space. In the intra-cellular space, the tracer furthermore divides into a bound fraction C₂ and a fraction C₃ that will finally leave the tissue via an extra-cellular compartment C₄. The definition of all symbols of this model is given in the following table:

| Symbol | Units | Comments |
|---|---|---|
| A | Bq | Measured activity of tracer |
| Cₚ, C_{1,} C₂ C₃ C₄ | Bq/ml | Concentrations of tracer |
| K₁ | 1/min | Rate constant |
| k₂, k_{3,} k_{4,} k₅ | 1/min | Rate constants |
| α | 1 | Fraction of bound products |
| β | 1 | Fraction of vascular space |
| η | 1 | Fraction of extracellular space |
| V | ml | |

Equation (1) describes the total activity A(t) that will be measured (for example by the PET-device 10 of FIG. 1) in a voxel of the image and that is a superposition of contributions from the tracer concentrations in all compartments. Equations (2)-(5) describe the differential equations for the single concentrations C₁, C₂, C₃, and C₄ of the tracer in the different compartments of the model. The concentration of the tracer in blood, Cₚ, which is the given input function for the model, is approximated in this approach by the generic function of equation (6). The general solution of equations (2)-(6) is given in equation (7), wherein F(x) is the gamma function, Γ(a,x) is the incomplete gamma function, and the parameters λₖ are defined according to equation (8).

In the computer 40 of FIG. 1, the library module 48 may particularly comprise analytical functions according to equation (7) or simplified versions thereof, wherein the parameters of equation (8) are estimated by a best fit of the resulting activity A(t) (equation (1)) to the measured data. If Cₚ is known from measurements, e.g. by drawing blood samples from the patient or by assessing the plasma concentration non-invasively from a suited ROI (e.g. the left ventricle of the heart), the parameters aᵢ, bᵢ, cᵢ may first be fitted to these measurements Cₚ, while the parameters λₖ are fitted thereafter to the image data.

Moreover, the library module 48 may contain analytical expressions for the gradients of the functions Cⱼ(t) with respect to their parameters, i.e. analytical expressions for

$$\frac{\partial {C}_{j}}{\partial {λ}_{k}} , \frac{\partial {C}_{j}}{\partial {a}_{i}} , \frac{\partial {C}_{j}}{\partial {b}_{i}} , and \frac{\partial {C}_{j}}{\partial {c}_{i}}$$

(not shown in FIG. 2).

Finally it is pointed out that in the present application the term “comprising” does not exclude other elements or steps, that “a” or “an” does not exclude a plurality, and that a single processor or other unit may fulfill the functions of several means. Moreover, reference signs in the claims shall not be construed as limiting their scope.

1. A data processing system (1) for the evaluation of image data (I) that represent the time varying concentration (A(t)) of at least one tracer substance in an object (20), comprising
a library module (48) comprising parameter dependent analytical functions that represent solutions to at least one given physiological compartment model;
an analysis module (47) that is adapted to fit the parameters (K₁, k₂, . . . ) of said analytical functions to the image data (I).

2. The data processing system (1) according to claim 1, characterized in that the library module (48) comprises analytical functions for a set of several compartment models from which a user may choose.

3. The data processing system (1) according to claim 1, characterized in that the library module (48) further comprises analytical expressions for the gradients of the analytical functions with respect to their parameters.

4. The data processing system (1) according to claim 1, characterized in that the analytical functions are of the form
$${C}_{j} ( t ) ∝ {ⅇ}^{- {λ}_{k} t} {\sum }_{i = 1}^{n} \frac{{a}_{i}}{{( {c}_{i} - {λ}_{k} )}^{{b}_{i} + 1}} [ Γ ( {b}_{i} + 1 ) - Γ ( {b}_{i} + 1 , ( {c}_{i} - {λ}_{k} ) t ) ] ,$$
wherein:
Cⱼ is the tracer concentration in a compartment j;
aᵢ, bᵢ, cᵢ and λₖ are parameters, wherein at least some of them shall be fitted to the image data;
Γ(x) is the gamma function and Γ(a,x) is the incomplete gamma function.

5. The data processing system (1) according to claim 1, characterized in that it is adapted to estimate the errors of the fitted parameters.

6. The data processing system (1) according to claim 1, characterized in that it is adapted to evaluate the compartment model selectively for every picture element or volume element of the image data (I) or for larger regions of interest.

7. The data processing system (I) according to claim 1, characterized in that is adapted to register the image data (I) and/or maps of the fitted parameters (K₁, k₂, . . . ) with images (I′) from the same or a different modality.

8. The data processing system (1) according to claim 1, characterized in that it comprises a display unit (60) for the display of image data (I), maps of the fitted parameters (K₁, k₂, . . . ), and/or maps of estimated parameter errors (σ_{K1}, σₖ₂, . . . ).

9. A record carrier on which a computer program for the evaluation of image data (I) that represent the time varying concentration (A(t)) of at least one tracer substance in an object (20) is stored, wherein said program is adapted to fit the parameters (K₁, k₂, . . . ) of analytical functions which represent solutions to at least one given physiological compartment model to said image data (I).

10. Examination apparatus, comprising
an imaging device (10) for generating image data (I) that represent the time varying concentration (A(t)) of at least one tracer substance in an object (20), particularly a PET-scanner;
a data processing system (1) according to claim 1.
